(19) United States
(12) Patent Application Publication
(10) Pub. No.: US 2023/0033015 A1
(43) Pub. Date: Feb. 2, 2023

(54) CLEANING DEVICE FOR CLEANING A VEHICLE ELEMENT

(71) Applicant: WITTE Automotive GmbH, Velbert (DE)

(72) Inventor: Lukás MRNUSTIK, Karlovy Vary (CZ)

(21) Appl. No.: 17/815,959

(22) Filed: Jul. 29, 2022

(30) Foreign Application Priority Data
Jul. 29, 2021 (DE) 10 2021 208 243.2

(51) Int. Cl. B60S 1/52

(52) U.S. Cl. CPC B60S 1/528

(57) ABSTRACT

The invention relates to a cleaning device (1) for cleaning a vehicle element, comprising at least a liquid supply source (8), a spray nozzle unit (3) and a housing (2) which encloses the spray nozzle unit (3) at least in portions and which can be arranged or is arranged in a vehicle component, wherein the spray nozzle unit (3) is linearly movable relative to the housing (2), wherein the spray nozzle unit (3) can be connected or is connected to the liquid supply source for the entry of a cleaning liquid, and wherein the spray nozzle unit (3) can be moved by means of pressure of the cleaning liquid when the cleaning liquid enters.

### FIELD

The invention relates to a cleaning device for cleaning a vehicle element.

### BACKGROUND

Washing devices having spray nozzles for cleaning vehicle elements or vehicle components are known from the prior art, in which devices a cleaning liquid is emitted in the form of a jet.

For example, a headlight device is known from DE 41 21 316 A1 which has a cylinder and a piston which is movably arranged in the cylinder and has a connection path for a washing liquid. Furthermore, the headlight device comprises a check valve which prevents the outflow of the washing liquid in the basic state, the check valve being arranged in such a way that a pressure of the washing liquid acts directly on the check valve in the axial direction and moves the check valve.

### SUMMARY

The object of the present invention is to specify a cleaning device for cleaning a vehicle element that is improved in comparison with the prior art.

With regard to an embodiment, the object is achieved according to the invention with a cleaning device for cleaning, for example, a vehicle element by the features specified in the claims.

A cleaning device according to the invention for cleaning a vehicle element comprises at least a liquid supply source, a spray nozzle unit and a housing which encloses the spray nozzle unit at least in portions and which can be arranged or is arranged in a vehicle component, the spray nozzle unit being linearly movable, for example extendable, relative to the housing, and the spray nozzle unit being connectable or connected to the liquid supply source for the entry of a cleaning liquid, the spray nozzle unit being able to be moved by means of pressure of the cleaning liquid when the cleaning liquid is supplied. In particular, the pressure of the cleaning liquid acts indirectly on a check valve of the cleaning device for passing on the cleaning liquid. This improves wear on individual components of the cleaning device.

The advantages achieved with the invention consist in particular in the fact that, for example, vehicle cameras or camera objectives and camera lenses can be cleaned effectively. The movable, in particular extendable, spray nozzle unit can be supplied with the cleaning liquid gradually, with the cleaning device in particular being less stressed in comparison with the solution proposed in the prior art. This increases the period of use of the cleaning device.

The movable spray nozzle unit can be used to increase an angle for dispensing the cleaning liquid relative to the surface to be cleaned, for example the vehicle component, in particular the camera or camera lens, in a simple manner such that the cleaning liquid can be supplied to the surface to be cleaned, for example a curved surface.

The cleaning device is designed in particular as a telescopically operable cleaning nozzle device for vehicle camera objectives. The spray nozzle takes over the cleaning of the vehicle camera lens in the extended state, also referred to as the use state. When not in use, i.e., in its idle state or non-use state, the spray nozzle disappears flush into and/or behind a vehicle surface.

The spray nozzle assembly is movable relative to the housing between an extended position, such as a cleaning position or a use state, and a retracted position, such as a stowed position, idle position or a non-use state.

For the entry or for the supply of the cleaning liquid, the housing has an entry opening, which is covered by the spray nozzle unit in an idle state thereof. When the cleaning liquid enters through the entry opening in the housing, the spray nozzle unit is movable relative to and away from the entry opening.

The spray nozzle unit is arranged at a distance from the entry opening in a use state and releases an inner space, for example an entry space, of the housing which is fluidically connected to the entry opening. The inner space can be filled with the cleaning liquid. The spray nozzle unit can be automatically moved away from the entry opening of the housing by the pressure of the cleaning liquid that is generated upon entry. For example, a manual and/or motorized adjustment of a desired position of the spray nozzle unit can be dispensed with.

The spray nozzle unit comprises a closed first end facing the entry opening of the housing and a second end provided with a nozzle opening, for example for dispensing the cleaning liquid toward an object to be cleaned. At least one inlet channel for the cleaning liquid is formed between the ends and in a body space of the spray nozzle unit, in particular for passing on the cleaning liquid.

In the region of the closed first end, the spray nozzle unit comprises a lateral inlet opening for the entry of the cleaning liquid into the inlet channel. The lateral inlet opening is formed in a wall of the spray nozzle unit that protrudes, for example protrudes vertically, from the closed end. The inlet opening is designed to extend obliquely, for example, with respect to the plane of the closed end. The inlet opening extends substantially in a straight line. The inlet opening can also be arcuate. The inlet opening is a through-opening or through-hole. For example, the inlet opening is formed at a predetermined angle in the wall. For example, the inlet opening projects at an angle of between 5° and 60°, for example 20° to 50°, for example 25° to 45°, away from the plane of the closed end.

The inlet opening connects the inner space or entry space of the housing to the inlet channel of the spray nozzle unit.

The lateral inlet opening is covered by an inner wall of the housing when the spray nozzle unit is in the idle state and is uncovered when the spray nozzle unit is in the use state. For example, the lateral inlet opening rests against an elevation or step or against an internal flange of the housing. Alternatively, the spray nozzle unit has a sealing portion corresponding to the inner wall of the housing, through which sealing portion the lateral inlet opening can be decoupled from the entry opening and/or from the entry space of the housing in the idle state. Only through the pressure of the cleaning liquid, which acts on the closed end of the spray nozzle unit, is the spray nozzle unit moved in such a way that the sealing portion comes out of contact with the inner wall and thus a fluid connection can be or is produced between the lateral inlet opening of the spray nozzle unit and the entry space of the housing.

The spray nozzle unit comprises at least one check valve, which is arranged in the region of the closed first end and/or in the inlet channel. The check valve is, for example, an opening check valve.

A check valve located at the closed first end of the spray nozzle unit may be connected to the first end. The check valve is, for example, form-fittingly, integrally and/or force-fittingly connected to the first end. The check valve can be designed to completely cover, in particular to close, the entry opening of the housing. When the cleaning liquid is supplied into or enters the entry opening, which extends through a housing portion, for example, the cleaning liquid acts on the check valve and thus the first end with a compressive force and moves the check valve out of the entry opening. The cleaning liquid can then enter the inner space or entry space of the housing. By moving the spray nozzle unit, the lateral inlet opening is uncovered, so that the cleaning liquid located in the inner space of the housing can flow through the lateral inlet opening into the inlet channel of the spray nozzle unit. The cleaning liquid is then dispensed through the nozzle opening in the direction of the surface to be cleaned.

For example, a check valve arranged in the inlet channel of the spray nozzle unit divides the inlet channel into two partial channels. The check valve can be moved linearly relative to the spray nozzle unit, for example. The check valve is held in the inlet channel so as to be linearly movable. For example, the check valve is spring-loaded. The pressure of the cleaning liquid counteracts a spring force of a spring element, which keeps the check valve prestressed, in such a way that the inlet channel is released in order to pass on the cleaning liquid. In the idle state of the spray nozzle unit, the spring element presses the check valve into its initial position, in which the inlet channel is blocked against liquid being passed on.

The cleaning device can be operated in two stages. The cleaning device can be adjusted, for example, in two stages from the idle state to the use state. The first stage relates to a first movement generated by the pressure of the cleaning liquid, in particular an extension movement, of the spray nozzle unit. The second stage relates to a second movement generated by the pressure of the cleaning liquid, in particular an adjustment movement, of the check valve in the inlet channel of the spray nozzle unit. For example, a pressure of the cleaning liquid can be better regulated.

Another cleaning device according to the invention comprises at least a housing, which can be arranged or is arranged in a vehicle component, for example, the housing being connectable or connected to a liquid supply source, and a spray nozzle unit that can be moved, for example extended, linearly relative to the housing. When a cleaning liquid is supplied, the spray nozzle unit can be moved relative to the housing, in particular by means of the pressure of the cleaning liquid, with the spray nozzle unit comprising at least one piston and a spray nozzle which is fluidically connected to the piston. The piston and/or the spray nozzle have/has at least one inlet opening formed on the side for passing the cleaning liquid from an inner region, in particular an inner space, of the housing in the direction of a nozzle opening of the spray nozzle, the inlet opening formed on the side being covered by an inner wall of the housing when the spray nozzle unit is in a retracted position and being uncovered in an extended position of the spray nozzle unit.

The piston and the spray nozzle form an inlet channel for the cleaning liquid, in which channel at least one check valve is arranged. For example, a check valve arranged in the inlet channel of the spray nozzle unit divides the inlet channel into two partial channels. The check valve can be moved linearly relative to the spray nozzle unit, for example. The check valve is held in the inlet channel so as to be linearly movable. For example, the check valve is spring-loaded. The pressure of the cleaning liquid counteracts a spring force of a spring element, which keeps the check valve prestressed, in such a way that the inlet channel is released in order to pass on the cleaning liquid. In the idle state of the spray nozzle unit, the spring element presses the check valve into its initial position, in which the inlet channel is blocked against liquid being passed on.

The cleaning device can be operated in two stages. The cleaning device can be adjusted, for example, in two stages from the idle state to the use state. The first stage relates to a first movement generated by the pressure of the cleaning liquid, in particular an extension movement, of the spray nozzle unit. The second stage relates to a second movement generated by the pressure of the cleaning liquid, in particular an adjustment movement, of the check valve in the inlet channel of the spray nozzle unit. For example, a pressure of the cleaning liquid can be better regulated.

In one embodiment, the housing has a connection point for connecting the cleaning device to the liquid supply source. The connection point comprises, for example, a channel which is fluidically connected to a hollow space or to the inner region of the housing for the passage of the cleaning liquid.

In one embodiment, the spray nozzle unit comprises at least one adjustable check valve, which is arranged in a connection region between the piston and the spray nozzle.

The advantages achieved with the invention consist in particular in the fact that, for example, vehicle cameras or camera objectives and camera lenses can be cleaned effectively. The extendable spray nozzle unit can be supplied with the cleaning liquid gradually, with the check valve in particular being less stressed in comparison with the solution proposed in the prior art. This increases the period of use of the cleaning device.

The cleaning device is designed in particular as a telescopically operable cleaning nozzle device for vehicle camera objectives. The spray nozzle takes over the cleaning of the vehicle camera objective in the extended state. When not in use, the spray nozzle disappears flush into a vehicle surface.

In one possible embodiment, the check valve is spring-loaded.

In a possible embodiment, the spray nozzle unit comprises a spring element which has a spring force directed against the pressure of the cleaning liquid.

The embodiments and/or individual features of the embodiments can be combined with one another to achieve the object.

### DESCRIPTION OF THE FIGURES

Embodiments of the invention are explained in greater detail with reference to the drawings, in which:

FIG. 1 is a schematic side view of an embodiment of a cleaning device having a housing and a movable spray nozzle unit arranged therein,

FIG. 2 is a schematic front view of the cleaning device according to FIG. 1,

FIG. 3 is a schematic exploded view of the cleaning device according to FIG. 1,

FIG. 4A is a schematic sectional view of the cleaning device according to FIG. 1,

FIG. 4B is a schematic sectional view of the cleaning device according to FIG. 1,

FIG. 5A is a schematic sectional view of an embodiment of a cleaning device having a housing and a movable spray nozzle unit arranged therein,

FIG. 5B is a schematic sectional view of an embodiment of a cleaning device having a housing and a movable spray nozzle unit arranged therein,

FIG. 5C is a schematic sectional view of an embodiment of a cleaning device having a housing and a movable spray nozzle unit arranged therein,

FIG. 6A is a schematic sectional view of another embodiment of a cleaning device having a housing and a movable spray nozzle unit arranged therein,

FIG. 6B is a schematic sectional view of another embodiment of a cleaning device having a housing and a movable spray nozzle unit arranged therein, and

FIG. 6C is a schematic sectional view of another embodiment of a cleaning device having a housing and a movable spray nozzle unit arranged therein.

Parts corresponding to one another are provided with the same reference signs in all the drawings.

### DETAILED DESCRIPTION

FIG. 1 is a schematic side view of an embodiment of a cleaning device 1 having a housing 2 and a movable spray nozzle unit 3 arranged therein.

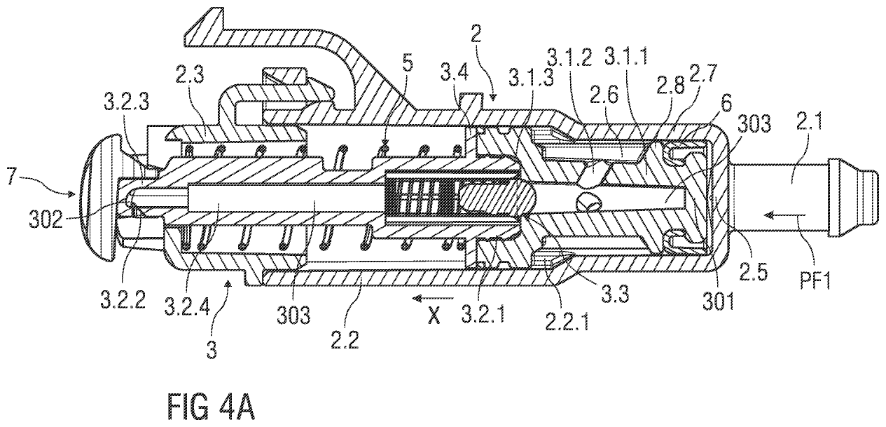

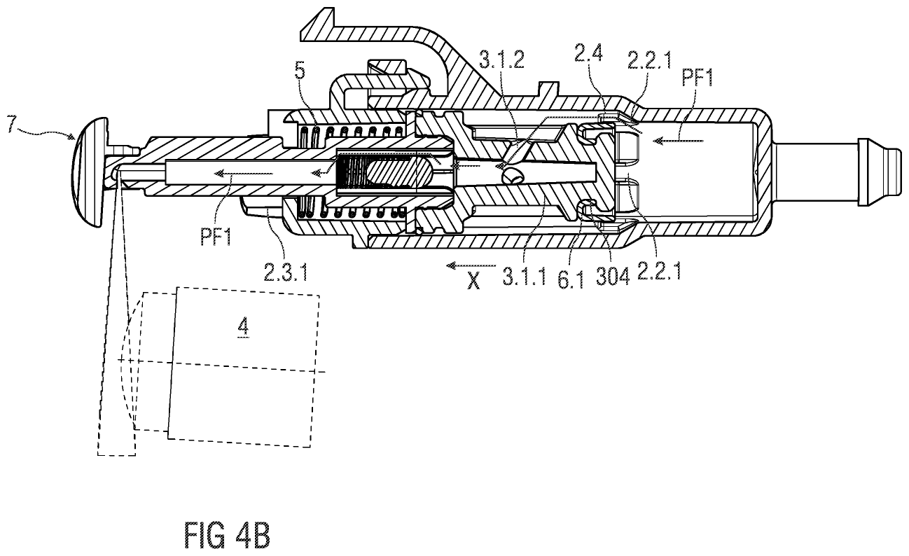

The housing 2 can be arranged or is arranged in a vehicle component, for example. The cleaning device 1 is provided for cleaning a vehicle camera 4, in particular an objective or a lens of the vehicle camera 4. The vehicle camera 4 is directed, for example, outward into a vehicle surroundings. In order to clean the vehicle camera 4 (shown schematically in FIGS. 4B and 5A to 6C), the spray nozzle unit 3 can be extended out of the housing 2 in order to supply a cleaning fluid to the objective or the lens of the vehicle camera 4 in the extended state.

The spray nozzle unit 3 can be connected or is connected to a liquid supply source 8 for the entry of a cleaning liquid. The spray nozzle unit 3 can be moved by means of pressure of the cleaning liquid when the cleaning liquid enters.

The housing 2 has a connection point 2.1 for coupling to the liquid supply source 8. The housing 2, in particular the connection point 2.1, has an entry opening 2.5 for the entry or for the supply of the cleaning liquid into the cleaning device 1.

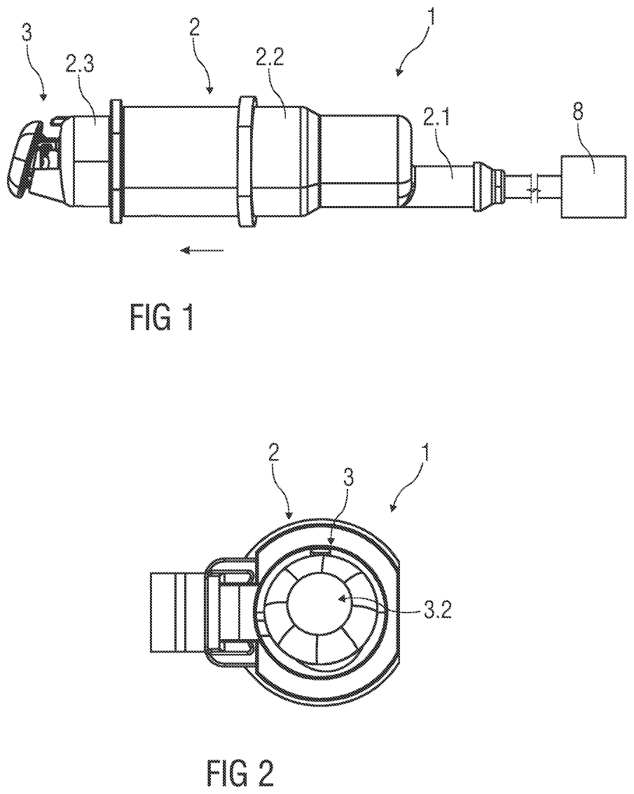

FIG. 2 is a schematic front view of the cleaning device 1 according to FIG. 1.

The housing 2 is substantially cylindrical. The movable spray nozzle unit 3 is arranged in a cavity of the housing 2. One end of the housing 2 has the connection point 2.1. Another end of the housing 2 has an opening through which the spray nozzle unit 3 is guided at least partially to the outside in an extended state. In a non-use state, the spray nozzle unit 3 is arranged so as to be sunk in the housing 2. When the spray nozzle unit 3 is in the extended state, it is arranged outside of the housing 2 in portions. The spray nozzle unit 3 is adjusted telescopically.

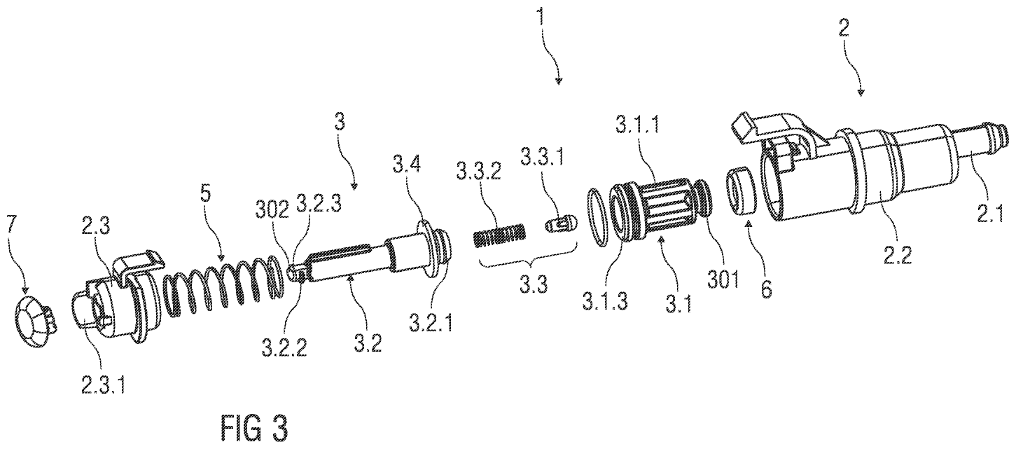

In a retracted non-use state of the spray nozzle unit 3, a spray nozzle head, for example a structural unit consisting of a spray nozzle 3.2 and a cover 7 (as shown in FIG. 3), can end flush with a vehicle outer shell.

The housing 2 has a first housing portion 2.2 and a second housing portion 2.3. In the assembled state of the cleaning device 1, the second housing portion 2.3 is attached to the first housing portion 2.2, in particular releasably attached. For example, the second housing portion 2.3 is clamped, clipped or screwed to the first housing portion 2.2.

FIG. 3 is a schematic exploded view of the cleaning device 1 according to FIG. 1.

The spray nozzle unit 3 comprises a piston 3.1 and a spray nozzle 3.2 coupled to the piston 3.1. By moving the piston 3.1, the spray nozzle 3.2 is also moved relative to the housing 2. In order to move the spray nozzle unit 3, in particular to extend the spray nozzle 3.2, the cleaning liquid acts on the cavity of the housing 2. The pressure of the cleaning liquid moves the piston 3.1 and thus the spray nozzle 3.2. The spray nozzle unit 3 is arranged at a distance from the entry opening 2.5 in a use state and releases an inner space 2.6 of the housing 2 which is fluidically connected to the entry opening 2.5.

The spray nozzle unit 3 comprises a closed first end 301 and a second end 302 provided with a nozzle opening 3.2.2, with at least one inlet channel 303 for the cleaning liquid being formed between the ends 301, 302.

The spray nozzle unit 3 comprises a movable check valve 3.3 or opening valve, which is arranged in a connection region between the piston 3.1 and the spray nozzle 3.2. The piston 3.1 comprises a piston body 3.1.1 having a cavity.

At one end of the piston 3.1, in particular an end assigned to the connection point 2.1 of the housing 2, the piston body 3.1.1 is closed. The piston body 3.1.1 is open at an end facing the spray nozzle 3.2.

The spray nozzle unit 3 is extended by the pressure of the cleaning liquid exerted on an upper side of the piston 3.1. This also moves the spray nozzle 3.2. During the movement of the piston 3.1, the cleaning liquid passes through side channels 2.2.1 in the first housing portion 2.2, which is designed, for example, in the form of a cylinder, and then through the lateral inlet opening 3.1.2 in the piston body 3.1.1, which, for example, is designed as a side channel 2.2.1, into the inner region in which the check valve 3.3 is located. The check valve 3.3 is, for example, a poppet check valve or a ball check valve.

The piston 3.1 is connected to the spray nozzle 3.2, in particular to the nozzle body thereof, by a press fit. The cleaning device 1 is returned to the retracted non-use state by a spring element 5 held in the housing 2. The spring element 5 is, for example, a compression spring or tension spring, in particular a steel spring. When the cleaning liquid is supplied, the spring element 5 is moved counter to its spring force. The pressure of the cleaning liquid must therefore be greater than the spring force of the spring element 5.

The check valve 3.3 is integrated into the part of the spray nozzle 3.2 which is uncovered or exposed during operation of the cleaning device 1. The check valve 3.3 consists of a sealing plug 3.3.1, for example made of silicone rubber, with a spherical sealing surface and a spring element 3.3.2, for example in the form of a compression or tension spring, in particular a steel spring.

FIGS. 4A and 4B are sectional views of the cleaning device 1 according to FIG. 1.

Furthermore, the piston body 3.1.1 has an inlet opening 3.1.2 formed on the side for passing on the cleaning liquid supplied through a side channel 2.1.1 of the connection point 2.1. The pressure built up when the cleaning liquid is supplied is sufficient to move the piston body 3.1.1 in the longitudinal direction X until the lateral inlet opening 3.1.2 is uncovered in order to pass on the cleaning liquid. At least one latching element 2.4 can be arranged on an inner wall of the housing 2, on which latching element the closed end of the piston body 3.1.1 locks in the extended state. In the extended state, the lateral inlet opening 3.1.2 is connected to the cavity of the housing 2 in such a way that the cleaning liquid can flow through the cavity into the inlet opening 3.1.2. The lateral inlet opening 3.1.2 on the side is covered by an inner wall 2.7, in particular by a shape, for example a stepped shape, of the housing 2 when the spray nozzle unit 3 is in the idle state and is uncovered when the spray nozzle unit 3 is in the use state. For example, the spray nozzle unit 3 comprises a flange portion 2.8 protruding outward. The spray nozzle unit 3 has a flange portion 2.8 corresponding to the inner wall 2.7 of the housing 2, which flange portion is ring-shaped, in particular has the form of a circumferential flange, through which the lateral inlet opening 3.1.2 can be decoupled from the entry opening 2.5 and/or from the inner space 2.6, for example the entry space, of the housing 2 in the idle state. Only through the pressure of the cleaning liquid, which acts on the closed end 301 of the spray nozzle unit 3, is the spray nozzle unit 3 moved in such a way that the flange portion 2.8, in particular in the form of a sealing portion, comes out of contact with the inner wall 2.7 and thus a fluid connection can be or is produced between the lateral inlet opening 3.1.2 of the spray nozzle unit 3 and the inner space 2.6, for example the entry space, of the housing 2. The flange portion 2.8 passes under pressure into a wider housing portion 2.2, so that the edge of the flange portion 2.8 comes out of contact with the inner wall 2.7.

Alternatively or additionally, a stop ring 3.4 arranged on the spray nozzle 3.2 comes into contact with the second housing portion 2.3, in particular with an end of the second housing portion 2.3 arranged in the first housing portion 2.2.

The stop ring 3.4 is designed, for example, in the form of a flange surrounding the spray nozzle 3.2. The spray nozzle 3.2 is arranged with its open plug end 3.2.1 in a recess 3.1.3 of the piston body 3.1.1. In particular, the plug end 3.2.1 is force-fittingly and/or form-fittingly fixed in the recess 3.1.3. Alternatively or optionally in addition, the stop ring 3.4 can be connected to the plug end 3.2.1, for example force-fittingly, form-fittingly and/or integrally connected.

A sealing ring 6 is arranged around the closed end 301 of the piston body 3.1.1. The sealing ring 6 is arranged partially or completely around the closed end 301 of the spray nozzle unit 3. The sealing ring 6 seals an end region of the spray nozzle unit 3 below or above, or in relation to the longitudinal direction X, upstream of or downstream of, the flange portion 2.8. The flange portion 2.8 is in contact with the sealing ring 6 via the side thereof facing the sealing ring 6. The sealing ring 6 is arranged between one end of the housing portion 2.2 and the flange portion 2.8.

As indicated in FIG. 4B, the piston body 3.1.1 comprises a recess 304 formed between the flange portion 2.8 and the closed end 301. The sealing ring 6 is arranged in the recess 304, for example. A diameter of the sealing ring 6 corresponds to a diameter of the flange portion 2.8. The sealing ring 6 has, for example, at least one retaining clip 6.1 on an end facing the flange portion 2.8. Another end of the sealing ring 6 is connected to the closed end 301. The retaining clip 6.1 is arranged, in particular braced, clamped and/or wedged, in the recess 304. The recess 304 can be designed as a groove extending around the piston body 3.1.1.

The first housing portion 2.2 comprises a first region having a smaller diameter, which has the entry opening 2.5. Furthermore, the housing portion 2.2 comprises a second region having a larger diameter, which faces the second housing portion 2.3. In other words, the first housing portion 2.3 is substantially conical or funnel-shaped.

The diameter of the flange portion 2.8 and that of the sealing ring 6 substantially correspond to the diameter, in particular an inner diameter, of the smaller portion of the first housing portion 2.2. In the non-use state or in the fully retracted state of the spray nozzle unit 3, the flange portion 2.8 and/or the sealing ring 6 is arranged in the first housing portion 2.2 in such a way that the first housing portion 2.2 is fluidically closed and sealed. In particular, a fluid connection between the side channels 2.2.1 of the first housing portion 2.2 and the entry opening 2.5 is separated, for example interrupted.

Due to the cleaning liquid, in particular due to the pressure of the cleaning liquid upon entry, the piston body 3.1.1 can be moved within the first housing portion 2.2 in such a way that the flange portion 2.8 is moved away from the first, smaller-diameter region in the direction of the second, larger-diameter region of the housing portion 2.2. When the flange portion 2.8 is arranged in the second region of the housing portion 2.2, the side channels 2.2.1 are uncovered and the cleaning liquid can pass through the flange portion 2.8 in the direction of the lateral inlet opening 3.2.1. The side channels 2.2.1 are arranged in a transition region between the first and the second region of the first housing portion 2.2.

The piston body 3.1.1 is substantially H-shaped, viewed in relation to the longitudinal direction X. The lateral inlet opening 3.2.1 is arranged in a connection region of the ends 301, 302 of the piston body 3.1.1. The connection region between the ends 301, 302 is smaller in diameter than that of the ends 301, 302. An inlet region for the cleaning liquid between the inner wall 2.7 and the piston body 3.1.1, in particular in the region of the lateral inlet opening 3.2.1, can thus be sufficiently large.

A direction of movement of the liquid flow is indicated by an arrow PF1 in FIG. 4A, 4B.

The spray nozzle 3.2 comprises the plug end 3.2.1 provided with an opening and an opposing nozzle opening 3.2.2 for dispensing the cleaning liquid in the form of a jet. The nozzle opening 3.2.2 is arranged on the side of the nozzle head 3.2.3. The position of the nozzle opening 3.2.2 can be formed depending on the orientation with respect to the vehicle element.

The plug end 3.2.1 and the nozzle opening 3.2.2 are fluidically connected to one another via a nozzle channel 3.2.4.

The check valve 3.3 is arranged in the nozzle channel 3.2.4. The pressure of the cleaning liquid moves the sealing plug 3.3.1 of the check valve 3.3 against a spring force of the spring element 3.3.2. This uncovers the nozzle channel 3.2.4, through which the cleaning liquid is passed in the direction of the nozzle opening 3.2.2. The spring element 3.3.2 is provided for resetting the sealing plug 3.3.1 when the supply of cleaning liquid is terminated. When the cleaning device 1 is in the retracted non-use state, the check valve 3.3 closes the nozzle channel 3.2.4.

A cover 7, for example a nozzle head cover or nozzle head cap, is provided for covering and protection. The cover 7 is integrally, force-fittingly and/or form-fittingly connected to the nozzle head 3.2.3.

Furthermore, the housing 2, in particular the second housing portion 2.3, comprises a cover wall 2.3.1 which protrudes outward for covering and protecting the lateral nozzle opening 3.2.2.

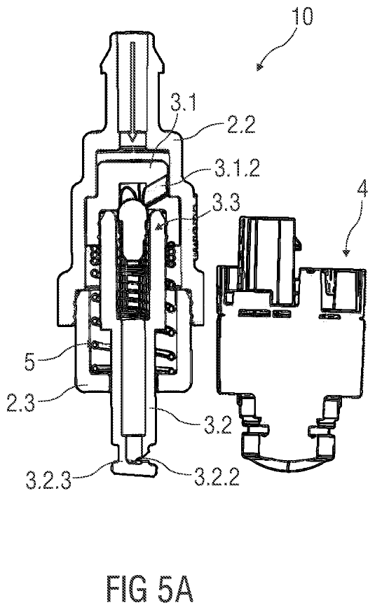

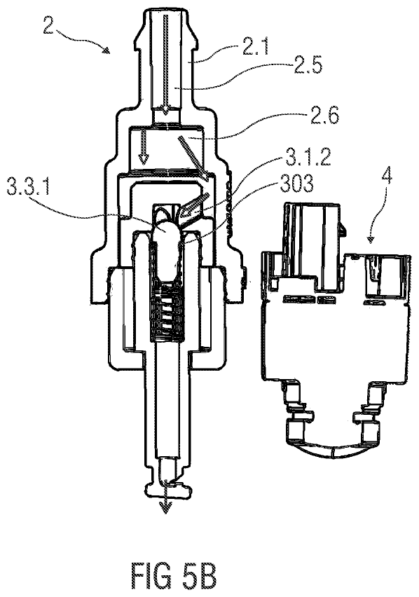

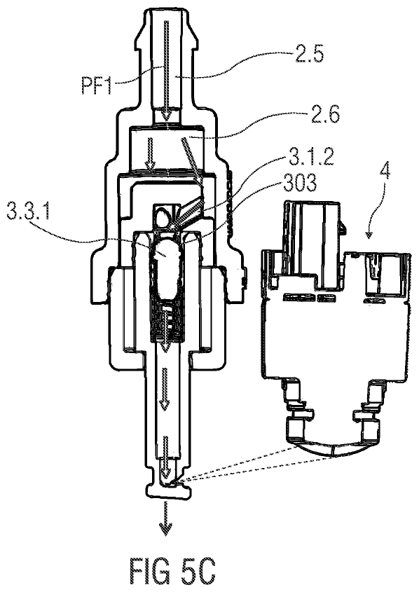

FIG. 5A to 5C are schematic sectional views of another embodiment of a cleaning device 10 having a housing 2 and a movable spray nozzle unit 3 arranged therein. The lateral inlet opening 3.1.2 is covered by an inner wall 2.7 of the housing 2 when the spray nozzle unit 3 is in the idle state and is uncovered when the spray nozzle unit 3 is in the use state.

FIG. 5A shows the cleaning device 10 in an initial state, for example in the non-use state, in particular in the retracted state of the spray nozzle unit 3.

FIG. 5B shows the cleaning device 10 in a partially extended state of the spray nozzle unit 3 and FIG. 5C shows the spray nozzle unit 3 in a fully extended state, in particular the use state.

The spray nozzle unit 3 comprises a piston 3.1 and a spray nozzle 3.2 coupled to the piston 3.1. By moving the piston 3.1, the spray nozzle 3.2 is also moved relative to the housing 2. In order to move the spray nozzle unit 3, in particular to extend the spray nozzle 3.2, the cleaning liquid acts on the cavity of the housing 2. The pressure of the cleaning liquid moves the piston 3.1 and thus the spray nozzle 3.2. The spray nozzle unit 3 is arranged at a distance from the entry opening 2.5 in a use state and releases an inner space 2.6 of the housing 2 which is fluidically connected to the entry opening 2.5.

In the fully retracted state of the spray nozzle unit 3, there is no fluid connection between the inlet channel 303 of the spray nozzle unit 3 and the inner space 2.6, in particular the entry space, of the housing 2.

In the partially extended state of the spray nozzle unit 3, the inlet channel 303 and the inner space 2.6 are fluidically connected, with the cleaning liquid being able to enter the piston body 3.1.1 through the entry opening 2.5, the inner space 2.6 and then through the lateral inlet opening 3.1.2. In this case, only then is the sealing plug 3.3.1 moved by the pressure of the cleaning liquid in such a way that the cleaning liquid can continue to pass through the inlet channel 303 to the side of the sealing plug 3.3.1. Here, the spray nozzle unit 3 is moved into the fully extended state.

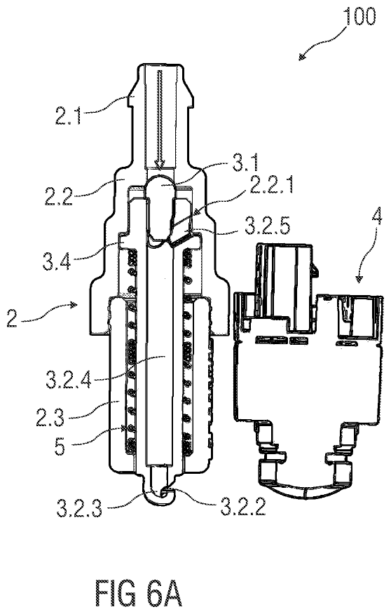

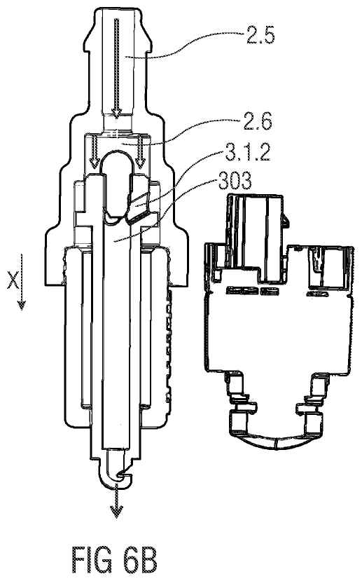

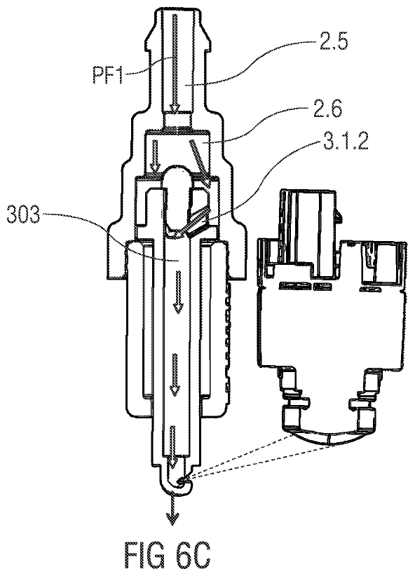

FIG. 6A to 6C are schematic sectional views of another embodiment of a cleaning device 100 having a housing 2 and a movable spray nozzle unit 3 arranged therein.

In contrast to the embodiments shown in FIGS. 1 to 5C, the cleaning device 100 shown here has no check valve 3.3.

Furthermore, the piston 3.1 is designed in the form of a plug and is attached to one end of the spray nozzle 3.2. A lateral inlet opening 3.2.5, which was previously formed on the piston 3.1, is formed on the spray nozzle 3.2. In the retracted state of the cleaning device 100, the inlet opening 3.2.5 is covered by a formation in an inner wall 2.7 of the first housing portion 2.2. In the extended state, the inlet opening 3.2.5 is uncovered after the spray nozzle 3.2 is moved in the longitudinal direction X. The lateral inlet opening 3.2.5 is covered by an inner wall 2.7 of the housing 2 when the spray nozzle unit 3 is in the idle state and is uncovered when the spray nozzle unit 3 is in the use state. The piston 3.1 and the spray nozzle 3.2 are designed in one piece, for example.

FIG. 6A shows the cleaning device 100 in an initial state, for example in the non-use state, in particular in the retracted state of the spray nozzle unit 3.

FIG. 6B shows the cleaning device 100 in a partially extended state of the spray nozzle unit 3 and FIG. 6C shows the spray nozzle unit 3 in a fully extended state, in particular the use state.

The spray nozzle unit 3 comprises a piston 3.1 and a spray nozzle 3.2 coupled to the piston 3.1. By moving the piston 3.1, the spray nozzle 3.2 is also moved relative to the housing 2. In order to move the spray nozzle unit 3, in particular to extend the spray nozzle 3.2, the cleaning liquid acts on the cavity of the housing 2. The pressure of the cleaning liquid moves the piston 3.1 and thus the spray nozzle 3.2. The spray nozzle unit 3 is arranged at a distance from the entry opening 2.5 in a use state and releases an inner space 2.6 of the housing 2 which is fluidically connected to the entry opening 2.5.

In the fully retracted state of the spray nozzle unit 3, there is no fluid connection between the inlet channel 303 of the spray nozzle unit 3 and the inner space 2.6, in particular the entry space, of the housing 2. The piston 3.1, in particular the plug head thereof, blocks the entry opening 2.5. The piston 3.1 can be moved away from the entry opening 2.5 by the pressure of the cleaning liquid.

In the partially extended state of the spray nozzle unit 3, the inlet channel 303 and the inner space 2.6 are fluidically connected, with the cleaning liquid entering the inner space 2.6 through the entry opening 2.5 and moving the piston 3.1 further by means of pressure in such a way that the cleaning liquid can enter the piston body 3.1.1 to the side of the piston 3.1 and to the side of the spray nozzle 3.2 through the lateral inlet opening 3.1.2. Here, the spray nozzle unit 3 is moved into the fully extended state.

It is noted that device parts not described in detail in FIGS. 5A to 5C and 6A to 6C also correspond to the device parts of the embodiment according to FIGS. 1 to 4B and/or at least correspond to one another.

### LIST OF REFERENCE SIGNS

1, 10, 100 Cleaning device
2 Housing
2.1 Connection point
2.2, 2.3 Housing portion
2.3.1 Cover wall
2.2.1 Side channel
2.4 Latching element
2.5 Entry opening
2.6 Inner space
2.7 Inner wall
2.8 Flange portion
3 Spray nozzle unit
3.1 Piston
3.1.1 Piston body
3.1.2 Inlet opening
3.1.3 Recess
3.2 Spray nozzle
3.2.1 Plug end
3.2.2 Nozzle opening
3.2.3 Nozzle head
3.2.4 Nozzle channel
3.2.5 Inlet opening
3.3 Check valve
3.3.1 Sealing plug
3.3.2 Spring element
3.4 Stop ring
301, 302 End
303 Inlet channel
304 Recess
4 Vehicle camera
5 Spring element
6 Sealing ring
6.1 Retaining clip
7 Cover
8 Liquid supply source
PF1 Arrow
X Longitudinal direction

1. Cleaning device (1) for cleaning a vehicle element, comprising at least:
a liquid supply source (8),
a spray nozzle unit (3) and
a housing (2) which encloses the spray nozzle unit (3) at least in portions and which can be arranged or is arranged in a vehicle component, wherein the spray nozzle unit (3) is linearly movable relative to the housing (2), wherein the spray nozzle unit (3) can be connected or is connected to the liquid supply source (8) for the entry of a cleaning liquid, and wherein the spray nozzle unit (3) can be moved by means of pressure of the cleaning liquid when the cleaning liquid enters.

2. Cleaning device (1) according to claim 1, wherein the housing (2) has an entry opening (2.5) for the entry of the cleaning liquid, which entry opening is covered by the spray nozzle unit (3) when the latter is in an idle state, wherein when the cleaning liquid enters, the spray nozzle unit (3) is movable relative to the entry opening (2.5) and away therefrom.

3. Cleaning device (1) according to claim 2, wherein the spray nozzle unit (3) is arranged at a distance from the entry opening (2.5) in a use state and releases an inner space (2.6) of the housing (2) which is fluidically connected to the entry opening (2.5).

4. Cleaning device (1) according to any of the preceding claims, wherein the spray nozzle unit (3) comprises a closed first end (301) and a second end (302) provided with a nozzle opening (3.2.2), wherein at least one inlet channel (303) for the cleaning liquid is formed between the ends (301, 302).

5. Cleaning device (1) according to claim 4, wherein the spray nozzle unit (3) comprises, in the region of the closed first end (301), a lateral inlet opening (3.1.2, 3.2.5) for the entry of the cleaning liquid into the inlet channel (303).

6. Cleaning device (1) according to claim 5, wherein the lateral inlet opening (3.1.2, 3.2.5) is covered by an inner wall (2.7) of the housing (2) when the spray nozzle unit (3) is in the idle state and is uncovered when the spray nozzle unit (3) is in the use state.

7. Cleaning device (1) according to any of claims 3 to 6, wherein the spray nozzle unit (3) comprises at least one check valve (3.3), which is arranged in the region of the closed first end (301) and/or in the inlet channel (303).

8. Cleaning device (1) for cleaning a vehicle element, comprising at least
a housing (2) which can be arranged or is arranged in a vehicle component,
a spray nozzle unit (3) which can be moved linearly relative to the housing (2) and which can be moved, in particular by means of the pressure of the cleaning liquid, when a cleaning liquid enters, wherein
the spray nozzle unit (3) comprises at least one piston (3.1) and a spray nozzle (3.2) which is fluidically connected to the piston (3.1), and wherein
the piston (3.1) and/or the spray nozzle (3.2) has at least one inlet opening (3.1.2, 3.2.5) formed on the side for conveying the cleaning liquid from an inner space (2.6) of the housing (2) in the direction of a nozzle opening (3.2.2) of the spray nozzle (3.2).

9. Cleaning device (1) according to claim 8, wherein the inlet opening (3.1.2, 3.2.5) formed on the side is covered by an inner wall (2.7) of the housing (2) when the spray nozzle unit (3) is in an idle state and is uncovered when the spray nozzle unit (3) is in a use state.

10. Cleaning device (1) according to either claim 8 or claim 9, wherein the piston (3.1) and the spray nozzle (3.2) form an inlet channel (303) for the cleaning liquid, in which channel at least one check valve (3.3) is arranged.
